(19) United States
(12) Patent Application Publication
(10) Pub. No.: US 2009/0074426 A1
(43) Pub. Date: Mar. 19, 2009

(54) MONOLITHIC DQPSK RECEIVER

(75) Inventor: Christopher DOERR, MIDDLETOWN, NJ (US)

Correspondence Address: BROSEMER, KOLEFAS & ASSOCIATES, LLC - (LUCENT), 1 BETHANY ROAD, BUILDING 4 - SUITE # 58, HAZLET, NJ, 07730, US

(73) Assignee: LUCENT TECHNOLOGIES INC., MURRAY HILL, NJ (US)

(21) Appl. No.: 11/856,000

(22) Filed: Sep. 14, 2007

(51) Int. Cl. H04B 10/06

(52) U.S. Cl. 398/202

(57) ABSTRACT

A monolithic, Indium Phosphide (InP) differential phase-shift keying (DPSK) or differential quadrature phase shift keying (DQPSK) receiver that exhibits low polarization sensitivity.

### FIELD OF THE INVENTION

This invention relates generally to the field of optical communications and in particular to a monolithic differential phase-shift keying (DPSK) or differential quadrature phase-shift keying (DQPSK) receiver fabricated from InP or other semiconductor material and exhibits low polarization sensitivity.

### BACKGROUND OF THE INVENTION

Optical differential phase-shift keying (DPSK), is an optical signal format in which each symbol is either a “1” or “−1”. It is called differential because the information is encoded as the phase difference between adjacent bits. Differential quadrature phase-shift keying (DQPSK) is an optical signal format in which each symbol is either “1+j”, “1−j”, “−1+j” or “−1−j”. It has a constellation of four points equally spaced around an origin and is a multi-level format that allows the transmission of N Gb/s with an optical bandwidth of only ˜N/2 GHz and electronics operating at only N/2 Gb/s. [See, e.g. R. A. Griffin et al, “10 Gb/s Optical differential quadrature phase shift key (DQPSK) transmission using GaAs/AlGaAs Integration,” Optical Fiber Communication Conference, paper FD6, 2002] Despite such desirable attributes, however, both DPSK and DQPSK transmission require a relatively complex receiver.

In particular, a conventional DQPSK receiver requires two Mach-Zehnder delay interferometers (DI) and two pairs of photodetectors (PD), and the path lengths connecting the components must be precise. Reducing the number of Mach-Zehnder delay interferometers to one provides some simplification while integrating the photodetectors with that delay interferometer produces even further simplification. Monolithic integration onto a semiconductor material would provide even further simplification and greatly reduces the footprint of the receiver. However producing such a monolithically integrated receiver that is also polarization insensitive has proven elusive to the art.

### SUMMARY OF THE INVENTION

An advance is made in the art according to the principles of the present invention whereby a monolithic DQPSK receiver is integrated in Indium Phosphide (InP) while exhibiting low polarization sensitivity. According to an aspect of the invention, the receiver includes an optical demodulator comprising a Mach-Zehnder delay interferometer (MZDI) having a multimode interference (MMI) coupler and a star coupler at either end of its two arms. The MZDI includes one or more polarization dependent phase shifters.

According to another aspect of the invention, further polarization independence is achieved when one of the MZDI arms includes a waveguide loop, in which is positioned a current injection phase shifter while the loop is positioned proximate to a thermooptic phase shifter. When monitor photodetectors are employed on particular output ports of the star coupler, a feedback control system is constructed whereby the phase shifters in the MZDI are automatically adjusted.

### BRIEF DESCRIPTION OF THE DRAWING

A more complete understanding of the present invention may be realized by reference to the accompanying drawings in which:

FIG. 1 is a schematic of a layout for an InP DPSK receiver according to the present invention;

FIG. 2 is a schematic of a layout for in InP DQPSK receiver according to the present invention;

FIG. 3 is a waveguide layout of a InP DQPSK receiver chip according to the present invention;

FIG. 4 is a waveguide layout of the InP DQPSK receiver chip of FIG. 3 showing long phase shifters and heater blocks;

FIG. 5 shows the measured fiber-to-fiber spectral response between the input and output test waveguides, measured over all polarizations at (FIG. 5A) iₚₛ=0 mA, and (FIG. 5B) iₚₛ=5.1 mA;

FIG. 6 is a graph showing measured MZDI peak spectral position, normalized to the DFSR, vs. phase shifter current into long phase shifter on the inner arm for both TE and TM polarizations;

FIG. 7 is a series of measured 21.5 Gbaud eye diagrams of one quadrature from PD#1 in four different conditions: FIG. 7A without polarization scrambling, phase-shifter current 1.6 mA; FIG. 7B with polarization scrambling, phase-shifter current 1.6 mA; FIG. 7C without polarization scrambling, phase shifter current 5.7 mA state; and FIG. 7D with polarization scrambling, phase-shifter current 5.7 mA;

FIG. 8 is a schematic of an alternative InP DQPSK receiver according to the present invention (FIG. 8(A) and layout of same (FIG. 8(B);

FIG. 9 is a cross-sectional view of waveguides and photodetectors used in InP DQPSK receiver chips according to the present invention;

FIG. 10 shows the measured transmissivity vs. wavelength through the Mach-Zehnder Delay Interferometer (MZDI) of FIG. 9, for the four star coupler outputs at all input polarizations wherein FIG. 10(A) is with no bias to the current injection phase shifter and FIG. 10(B) is with 18 mA to the current injection phase shifter;

FIG. 11 is a series of measured 26.75 Gbaud eye diagrams of one quadrature from PD#1 in four different conditions: FIG. 11A without polarization scrambling, phase-shifter current 1.6 mA; FIG. 11B with polarization scrambling, phase-shifter current 1.6 mA; FIG. 11C without polarization scrambling, phase shifter current 5.7 mA state; and FIG. 11D with polarization scrambling, phase-shifter current 5.7 mA; and

FIG. 12 shows both a schematic FIG. 12A and layout FIG. 12B of an alternative embodiment of the present invention including two additional photodetectors.

### DETAILED DESCRIPTION

The following merely illustrates the principles of the invention. It will thus be appreciated that those skilled in the art will be able to devise various arrangements which, although not explicitly described or shown herein, embody the principles of the invention and are included within its spirit and scope.

Furthermore, all examples and conditional language recited herein are principally intended expressly to be only for pedagogical purposes to aid the reader in understanding the principles of the invention and the concepts contributed by the inventor(s) to furthering the art, and are to be construed as being without limitation to such specifically recited examples and conditions.

Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the diagrams herein represent conceptual views of illustrative structures embodying the principles of the invention.

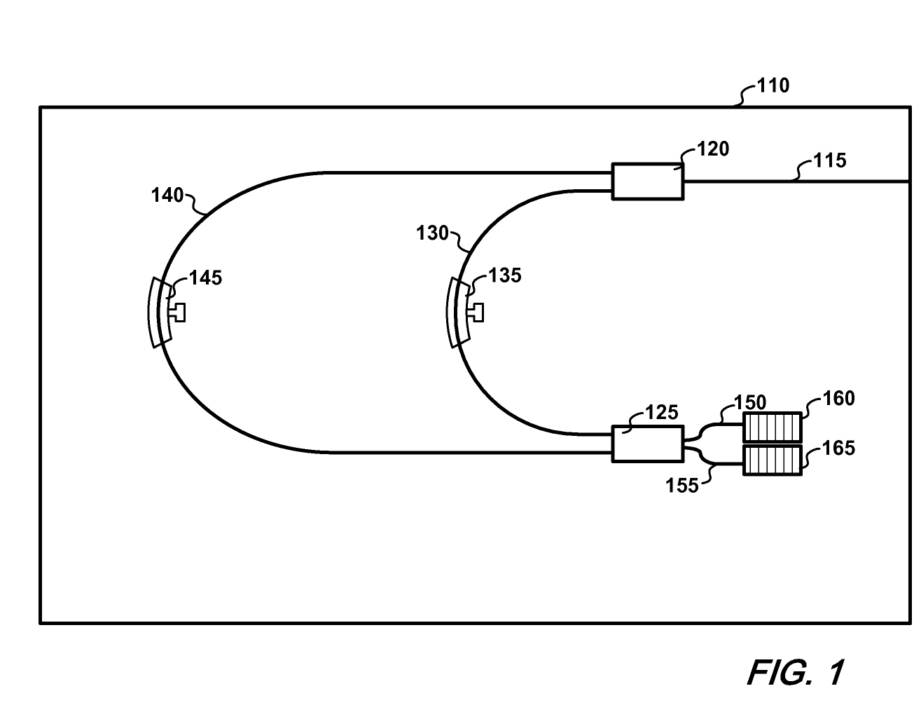

With initial reference to FIG. 1, there is shown a layout schematic for a DPSK Mach-Zehnder delay interferometer with phase shifters according to the present invention. As shown in this FIG. 1, the device comprises a substrate chip 110—which in this preferred embodiment is Indium Phosphide (InP). Onto the chip 110 is disposed a MZDI which includes a pair of unequal-length waveguide arms 130, 140 which are connected at each of their ends by waveguide couplers 120, 125. In a preferred embodiment, the path-length difference between 130 and 140 is usually designed to be approximately one symbol length of the inputted data signal. Shown further are two output waveguides 150, 155 which are connected at one of their ends to coupler 125, while the other ends are directed into photodetectors 160, 165. Each of the unequal length waveguide arms 130, 140 includes a phase shifter 135, 145.

With this overall structure in place, it is readily apparent to those skilled in the art that an optical signal received at an input waveguide 115, it is split through the effect of the 1×2 waveguide coupler 120 and directed into the two unequal-length waveguide arms 130, 140. It is then received by 2×2 output coupler and directed into output waveguides 150, 155 and then into photodetectors 160, 165, respectively.

However, MZDIs typically exhibit a polarization-dependent wavelength (PDW) shift due to birefringence in the waveguides. The PDW shift can be especially large in semiconductor materials, such as InP, because it is difficult to make a waveguide with a square cross section in semiconductor materials.

One aspect of the present invention is that the MZDI is polarization independent. According to an aspect of the invention, a forward-injection phase shifter is disposed in one of the arms of the MZDI. There is a p-n junction in the waveguide, and the current injection causes a phase shift due to carrier density changes. Because such a forward-injection phase shifter provides a polarization-dependent phase shift (because the transverse electric (TE) and transverse (TM) modes have a different mode overlap with the p-n junction, appropriate adjustment of the phase shifter can result in the MZDI being polarization insensitive. When arranged in this manner, a PDW shift in the MZDI may be measured. If it is too large, then one of the phase shifters can be driven to an amount that makes the PDW shift substantially equal to zero.

In order to subsequently tune the wavelength of the MZDI to match the signal wavelength, the entire chip temperature may be adjusted or preferrably a thermooptic phase shifter may be positioned in one of the MZDI arms. As those skilled in the art may readily appreciate, the thermal effect has a very low polarization dependence and therefore is quite good for adjusting the wavelength without affecting the polarization dependence. Because there is already a current injection phase shifter directly on top of the MZDI arms (to achieve the polarization independence), the thermooptic phase shifter must be offset slightly to the side of the waveguide.

In addition, one can also position another element in the MZDI arms for arm-loss balancing in order to achieve a high extinction-ratio. The element can be a reverse-biased phase shifter which acts as an electro-absorption attenuator. By adjusting this attenuator and one of the forward-biased phases shifters, one can simultaneously achieve a higher extinction ration and low polarization dependence. Preferably, the attenuator should use tensile-strained materials that have a low polarization dependence.

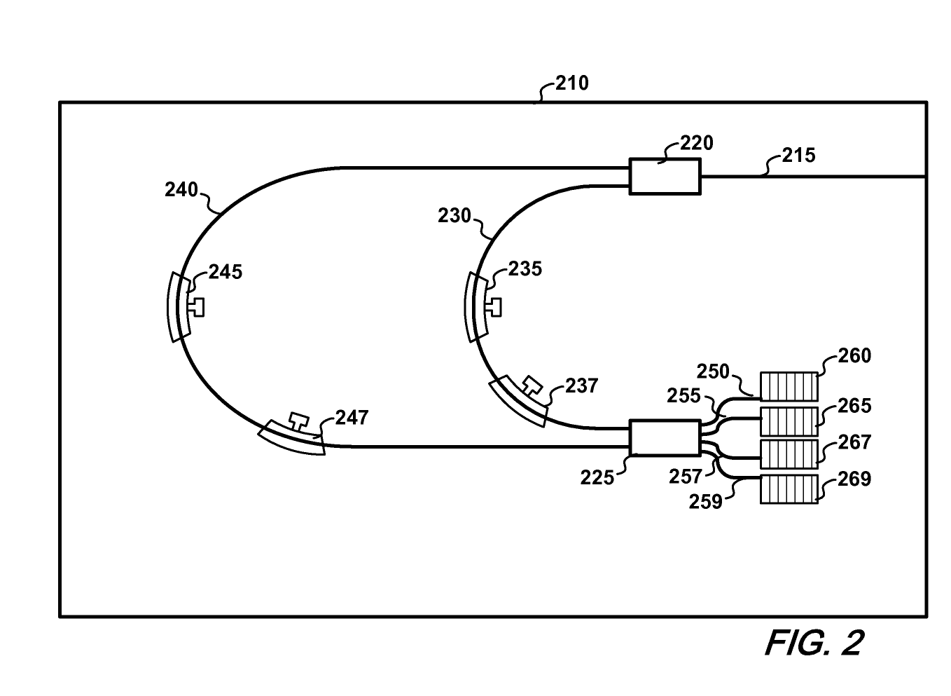

Advantageously, the principles of the present invention are extensible to a DQPSK receiver, as shown in FIG. 2. As generally implemented, such a DQPSK receiver comprises an InP chip 210 onto which is integrated MZDI having two unequal length arms 230, 240 and two couplers 220, 225, the first being a 2×2 coupler and the second being a 2×4 coupler. The 2×4 coupler serves as a 90-degree hybrid. Such a 2×4 coupler used for demodulating DQPSK is further explained in U.S. patent application No. 20050286911, entitled “Apparatus and method for receiving a quadrature differential phase shift key modulated optical pulsetrain”, by Doerr and Gill and assigned to the present assignee of the instant invention. Into the arms are integrated phase shifters 235, 245 and attenuators 237, 247. As noted above, the attenuators may preferably be constructed from tensile-strained materials that exhibits a low polarization dependence.

Finally, the output of the 2×4 coupler 225 is directed into a number of output waveguides 250, 255, 257, 259 which may be detected by a number of photodetectors 260, 265, 267, 269.

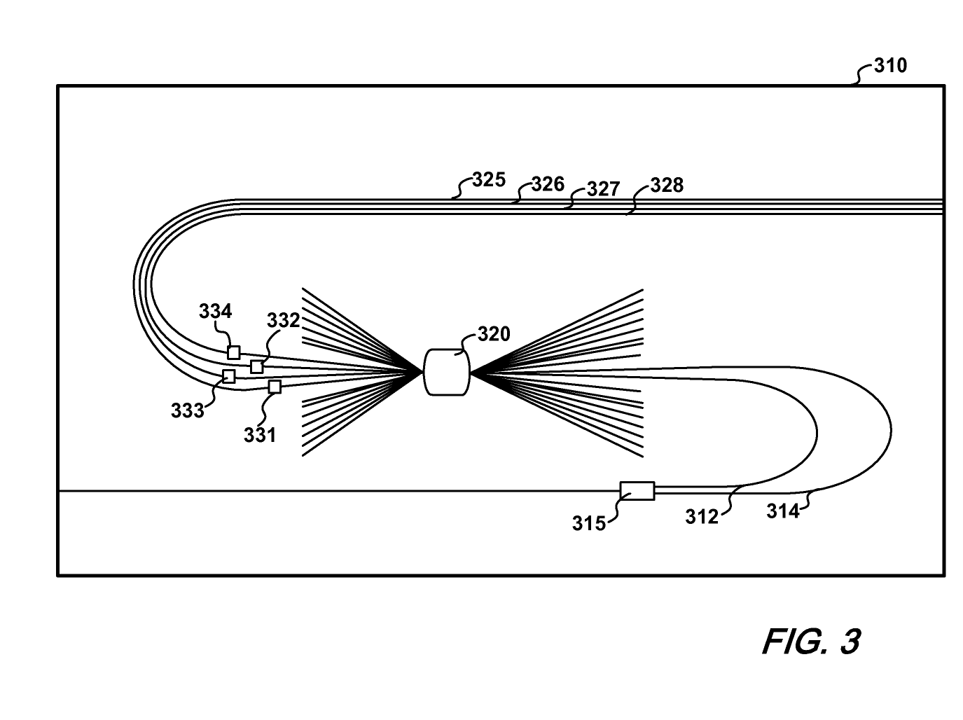

Turning now to FIG. 3, there is shown a waveguide layout of an exemplary InP DQPSK receiver chip 300 according to the present invention. As shown in FIG. 3, onto an InP substrate 310 are integrated a 1×2 multi-mode interference (MMI) coupler 315, two waveguides 312, 314 having a differential delay of substantially 18.7 ps—which those skilled in the art will recognize as being a one-symbol delay for a 107-Gb/s DQPSK; a 2×4 star coupler 320; and 4 output waveguides 325, 326, 327, 327.

As implemented, four waveguide photodetectors 331, 332, 333, and 334 preferably arranged as two pairs, 331 and 332, 333 and 334, are positioned equidistant from the star coupler 320. As can be observed from FIG. 3, the photodetector waveguides continue on as output waveguides 325, 326, 327, 327 and terminate at an edge facet of the InP substrate chip 310 providing a convenient measurement point for measuring spectral response. As can be appreciated by those skilled in the art, the output waveguides that conduct light off-chip may be advantageously eliminated from a production device.

In a preferred test embodiment, the waveguides are 2.1 μm-high ridges with a benzocyclobutene (BCB) upper cladding and have substantially the same structure which includes an n-doped layer, 8 tensile-strained quantum wells (QWs) surrounded by 10-nm separate confinement layers, a 250-nm undoped InP layer, and a p-doped layer. The QW band-edge is at ˜1600 nm. Those skilled in the art will of course recognize that such a structure may be employed in modulators.

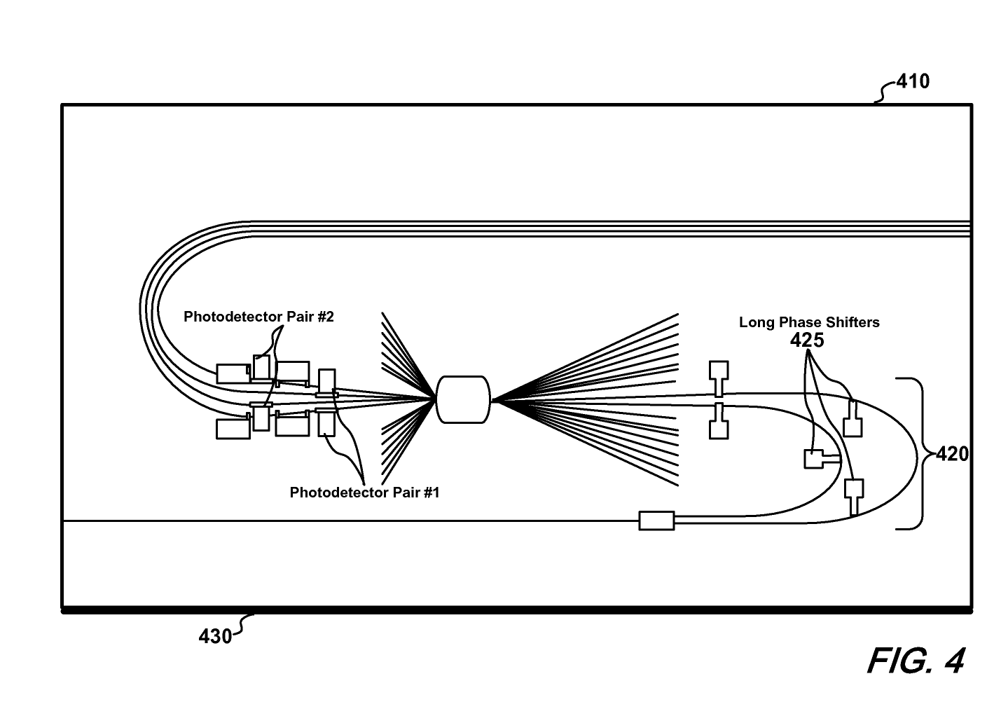

Turning now to FIG. 4, there is shown a layout of an InP DQPSK receiver chip according to the present invention. More particularly, the chip 410 includes a delay interferometer (DI) 420 exhibiting a delay of substantially 18.7 ps. The MZDI 420 includes a number of long phase shifters 425 (˜1.5 mm) which are operated by current injection. As can be appreciated, the phase shifters 425 are polarization-dependent and null-out the net polarization dependent wavelength (PDW) shift of the MZDI 420 at a desired wavelength. The phase adjustment of the MZDI to 420 align it with an applied data signal may be accomplished by adjusting the overall chip temperature through the use of one or more chip heaters 430—which may advantageously underlie the chip—combined with relatively small adjustments of the phase shifters 425.

In evaluating the InP DQPSK receiver according to the present invention, the chip was soldered to a copper block, which was placed onto a thermoelectric cooler. It was accessed optically via lensed fibers. No anti-reflection coatings were applied.

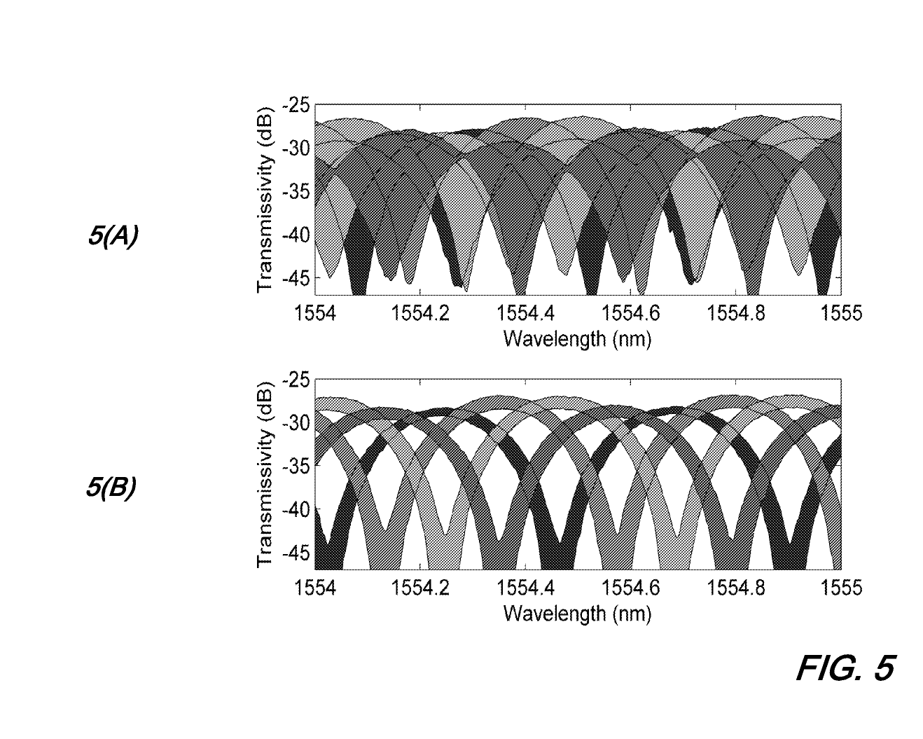

The measured fiber-to-fiber transmissivities from the input waveguide to each of the four output test waveguides are shown in FIG. 5A. The filled regions in the spectral response represent the extent of the transmissitivity over all polarizations. The polarization-dependent loss is ˜1.5 dB, and the PDW shift is ˜25 GHz.

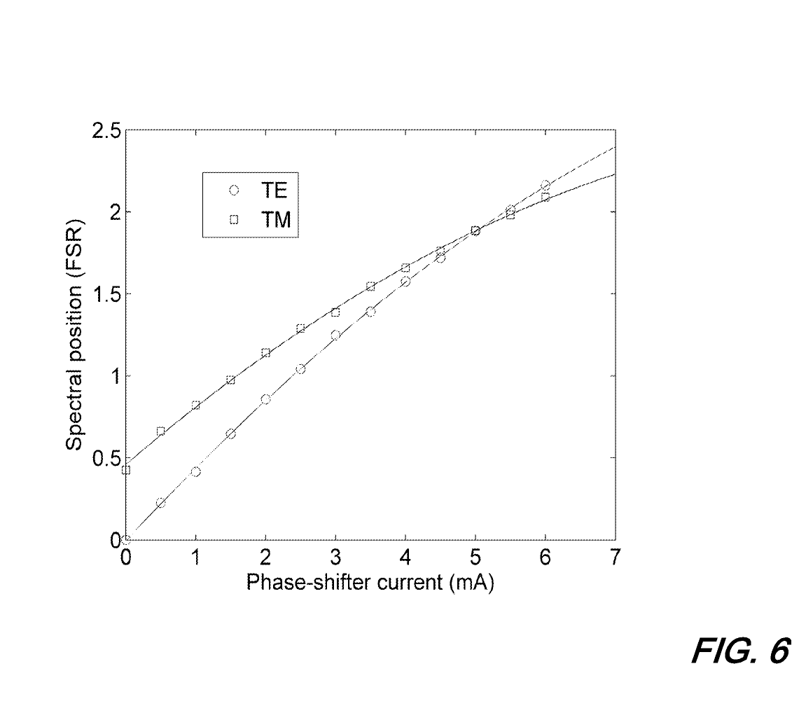

Subsequently, current was injected into the long phase shifter iₚₛ, on the shorter arm of the DI. The spectral locations in wavelength, normalized to MZDI free-spectral range (FSR) of the peaks for the two polarizations for output #3 as a function of injection current are shown in the graph in FIG. 6. The TM polarization shifts at a rate of 0.75 that of TE. This value is similar to the 0.80 value found for a current-injected phase shifter which contained no quantum wells.

As can be appreciated by those skilled in the art, a current-injected phase shifter is not expected to exhibit polarization sensitivity, however because the TE mode is wider and shorter than the TM mode, and the intrinsic region where the carriers are injected is wide and short, the mode-overlap with the carrier injection regions is greater for TE than TM. Again, those skilled in the art will recognize that this is different from that of a thermo-optic phase shifter in silica, in which TM shifts at a rate of ˜1.04 that of TE and is due largely to strain and not mode shape.

At a current of ˜5 mA, the spectral responses of TE and TM overlap at 1550 nm. The measured spectral responses under these conditions are shown in FIG. 5B. The PDW shift is significantly reduced, to 3.2 GHz. Note that the PDW shift must be <˜1 GHz to demodulate 107-Gb/s DQPSK signals.

Regardless of phase shifter adjustment, the PDW shift does not fall below 3.2 GHz because polarization states that are combinations of TE and TM exhibit spectral shifts. Therefore, there is polarization crosstalk somewhere in the DI, which is known to limit the elimination of PDW in silica waveguide DIs. Polarization crosstalk has been observed in InP bends.

The slope of total phase shift vs. current decreases with increasing current, and it eventually saturates. This is one reason why the phase shifter needs to be relatively long, to avoid saturating before null PDW conditions are achieved. Advantageously, it was found on several chips that this technique could reduce the PDW shift to 1-3 GHz before reaching saturation.

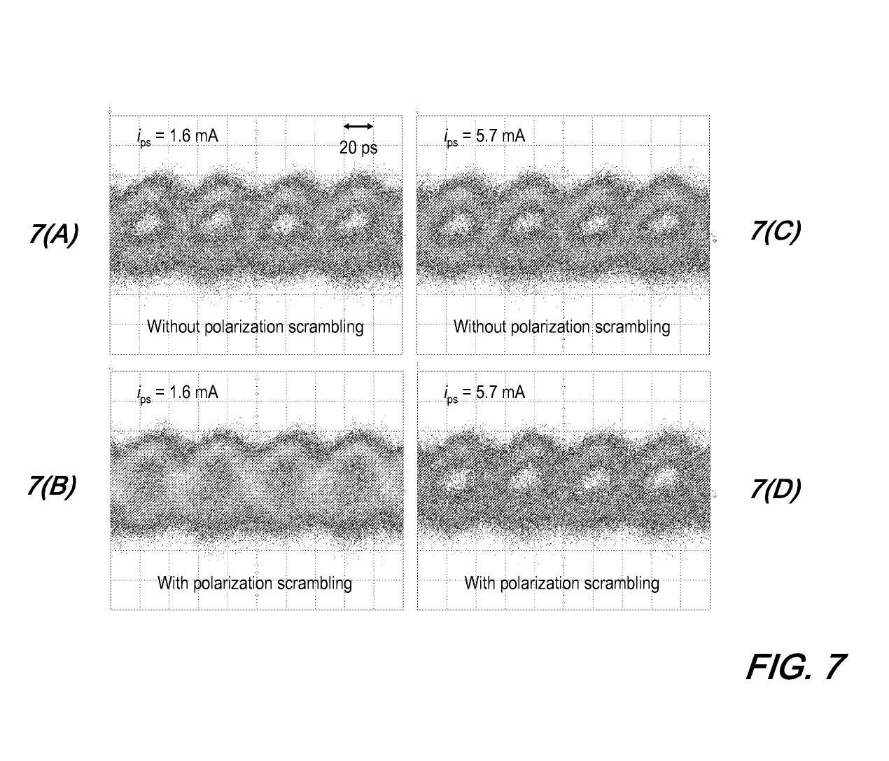

To test the receiver, a 43-Gb/s non-return-to-zero (NRZ) DQPSK signal at 1550 nm was launched into the chip. At this rate, the MZDI has a delay of only 0.4. symbols. A fractional-symbol MZDI can tolerate a larger PDW shift than a unit-symbol DI, however there is an overall reduction in sensitivity. The measured eye diagram of one of the demodulated quadratures from one PD (using single ended detection) is shown in FIG. 7A, when the drive current to the long phase shifter on the MZDI shorter arm is close to zero and the polarization is optimized to produce the best eye diagram. Additionally, a polarization scrambler inserted before the receiver, closed the eye due to the high polarization dependence as shown in FIG. 7B. The phase shifter was then adjusted to the low PDW condition and was measured without and with the polarization scrambler, as shown in FIGS. 7C and 7D, showing the low polarization dependence.

The MZDI demodulated both quadratures of the DQPSK signal, but the phase had to be slightly readjusted to optimize each quadrature, indicating that the phase differences in the 2×4 star coupler are not exactly integer multiples of 90°. Of course, these phases may be adjusted in alternative arrangements for a desired wavelength.

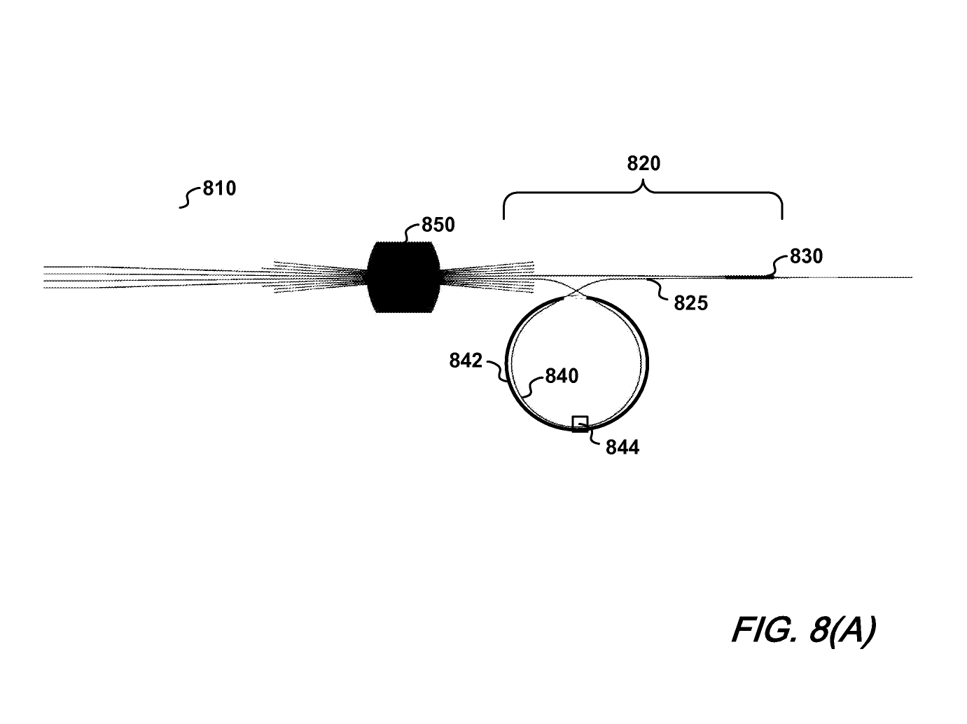

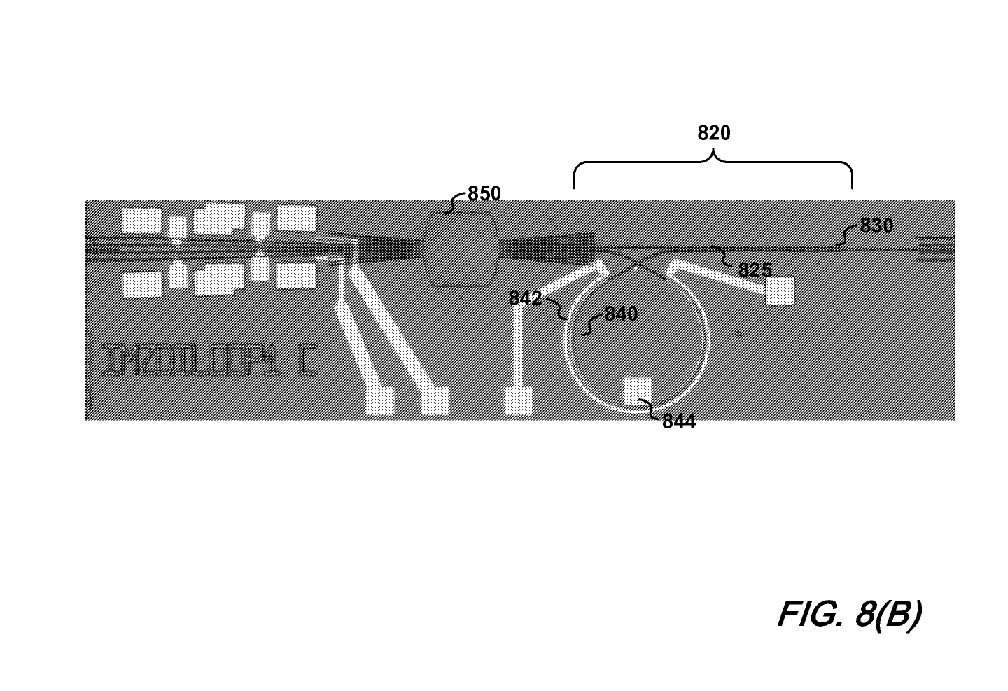

Turning now to FIGS. 8A and 8(B), there is shown a waveguide layout for an alternative arrangement of a monolithic InP DQPSK receiver according to the present invention. As shown, the InP chip 810 includes an optical demodulator 820 comprising a MZDI 825 with a multimode interference (MMI) coupler 830 at one end and a 2×4 star coupler 850—serving as a 90-degree hybrid—at another end. In this exemplary embodiment, the MZDI path-length time difference is 18.7 ps.

As can be observed from FIG. 8(A) and FIG. 8(B), the long arm of the MZDI 825 includes a loop 840 proximate to a thermooptic phase shifter 842 and a current injection phase shifter 844. While not specifically shown in FIG. 8(A) or FIG. 8(B), the thermooptic phase shifter effectively surrounds the loop 840. As explained earlier, the current injection phase shifter is for mitigating the PDW shift, and the thermooptic phase shifter is for adjusting the MZDI phase. In addition, and also not specifically shown in this FIG. 8(A) or FIG. 8(B), the input to the MMI is slightly offset in order to compensate for the increased total propagation loss and the waveguide crossing in the longer arm of the interferometer.

Advantageously, by using a small loop having a bend radius of 240 μm say for the MZDI delay, a much smaller device may be constructed.

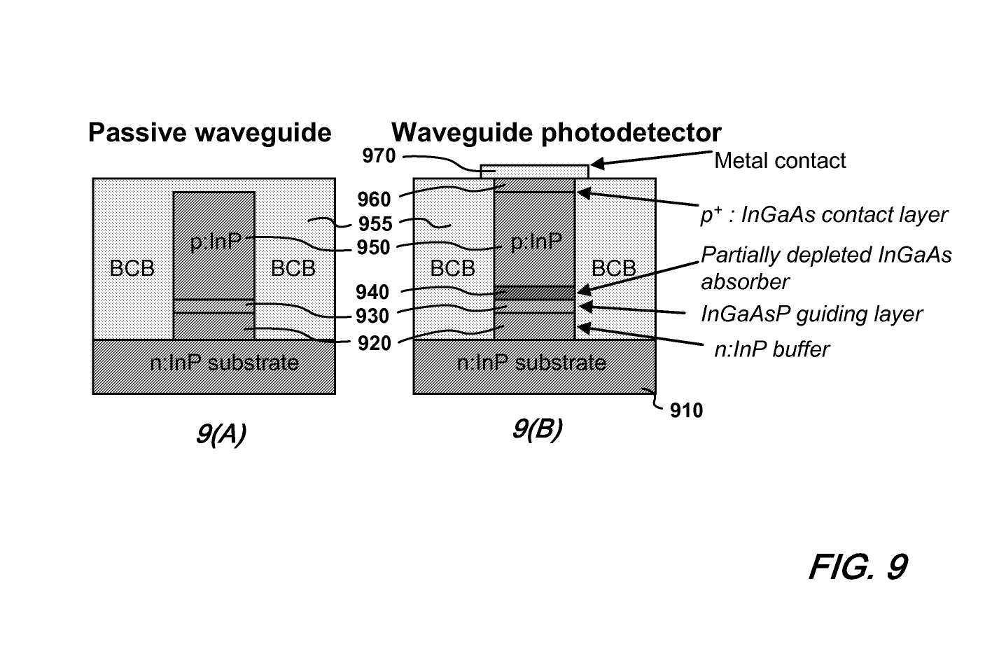

Advantageously, and with reference now to FIG. 9, the structures employed in the DQPSK receiver according to the present invention are fabricated via conventional methods. Shown in FIG. 9 are the passive waveguide (FIG. 9(A) and waveguide photodetector structures (FIG. 9(B)) in cross section. As shown, a layered structure is employed and onto an n-doped wafer substrate 910 is grown a buffer layer 920, a guiding 1.4 μm bandgap InGaAsP layer 930, and an InGaAs absorber layer 940 which is p-doped substantially one-third of the way through. Subsequently, InGaAs is removed but from the PDs. Onto the absorber layer 940 is grown an InP layer 950, starting with an undoped set back layer of substantially 120 nm and then ˜1 μm of InP with gradually increasing p-doping. The structures are finished by adding a contact layer 960 and by planarizing with benzocyclobutene (BCB) and BCB etching 955 and metal deposition of a metal contact 970. As shown in FIG. 9(A) and FIG. 9(B), not all of the layers are constructed in both structures.

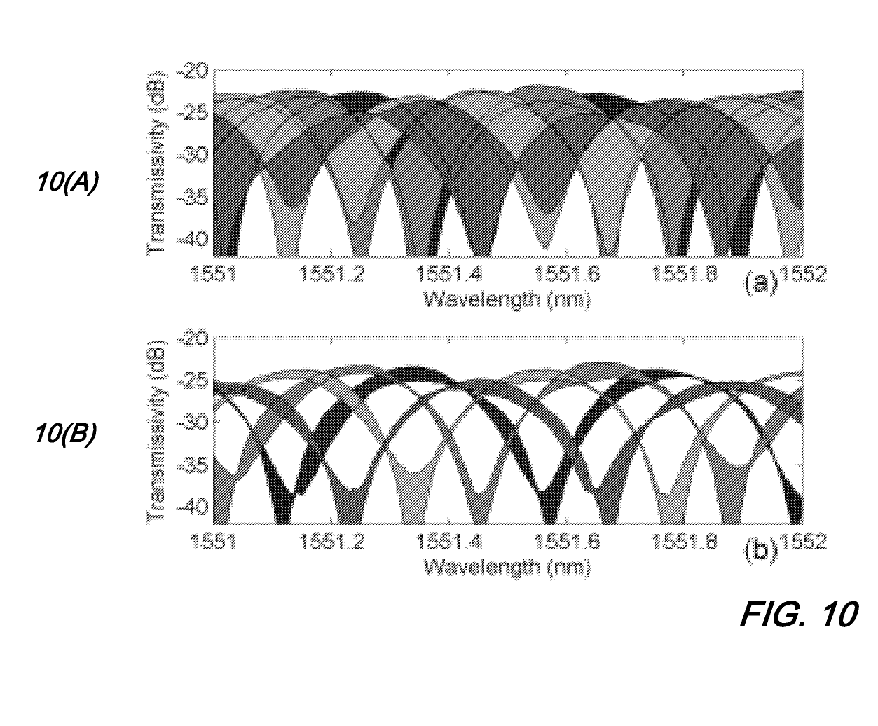

The transmission spectra from the input to the four output waveguides are shown in FIG. 10. More specifically, FIG. 10 shows the spectra measured with 0 mA (FIG. 10(A)) and with 18 mA (FIG. 10(B)) drive to the current-injection phase shifter 844. 18 mA is the current that provides minimum PDW shift.

As one can observe from these spectra plotted in FIG. 10, the polarization-dependence of the current-injection phase shifter advantageously mitigates PDW SHIFT. The PDW SHIFT does not reach zero however, probably due in part to polarization crosstalk in the couplers and/or bends.

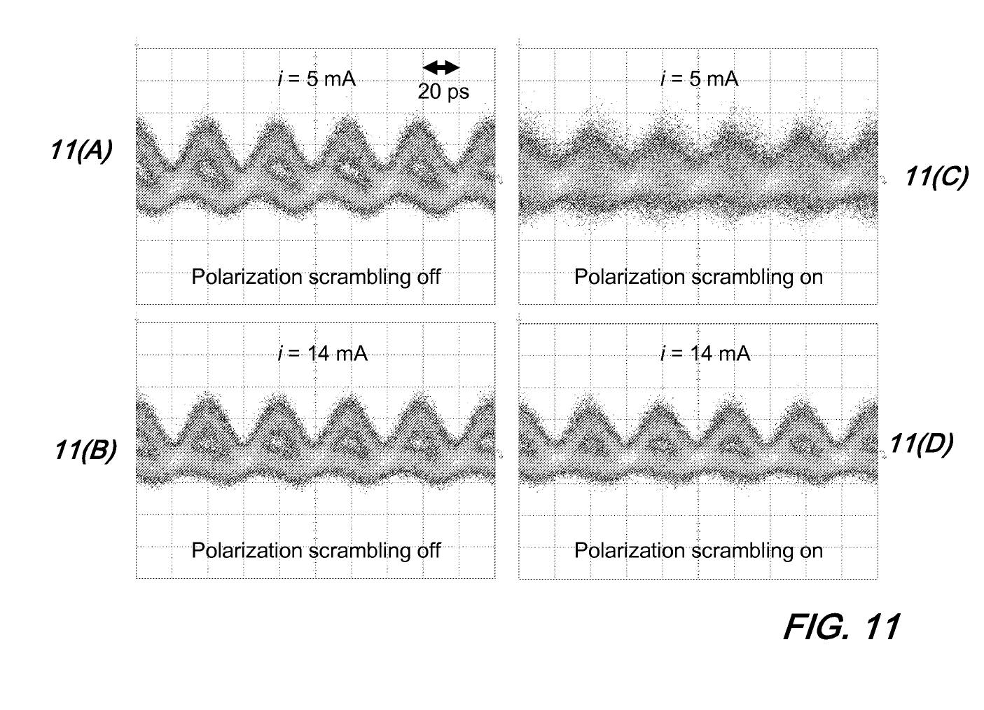

To collect the PD photocurrent a high-speed ground-signal-ground probe having an internal 50-ohm termination was used. The PDs required a bias of −4V. To evaluate the device a 53.3-Gb/s return-to-zero (RZ)DQPSK signal at 1550 nm was launched into the chip. The launch power was +17 dBm and a polarization scrambler was placed at the input to check polarization dependence of the chip. FIG. 11 shows a series of eye diagrams for one of the quadratures using one PD. With a low bias to the current-injection-phase shifter, the PDW shift is large and therefore the eye diagram is closed when polarization scrambling is on, as shown in FIG. 11(B). When phase-shifter bias is adjusted for minimum PDW shift, the eye stays open during polarization scrambling, as shown in FIG. 11(D).

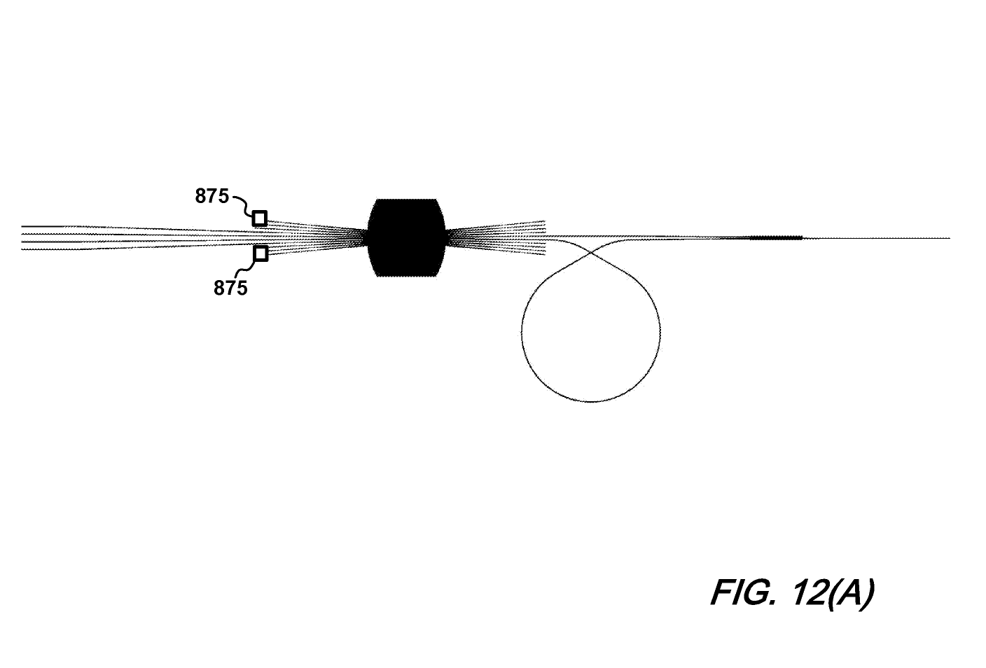

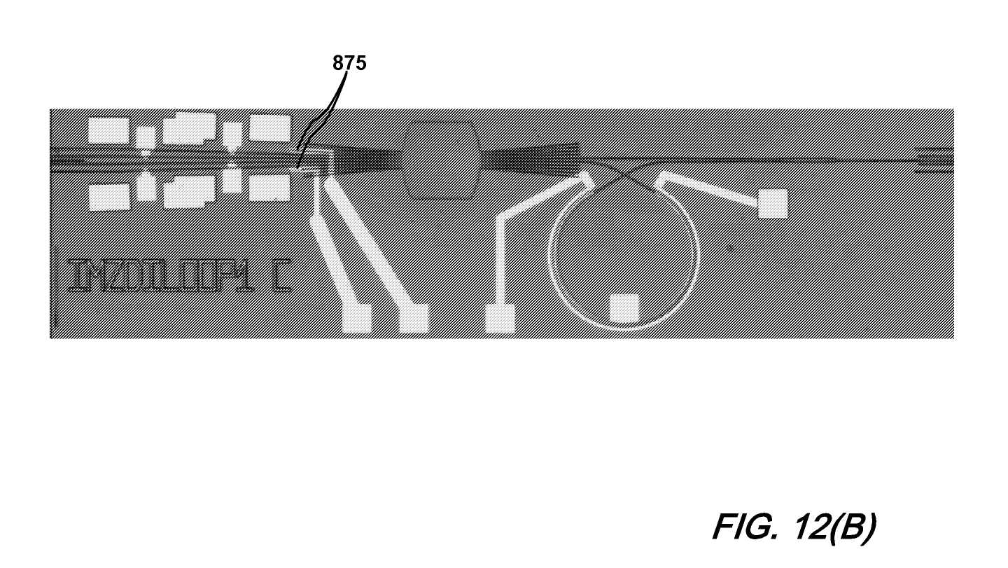

Finally, FIG. 12 shows an alternative embodiment of the present invention. With simultaneous reference to FIG. 12(A) and FIG. 12(B), it may be observed that the receiver structure includes at least two additional photodetectors 875 which may be conveniently called, “monitor photodetectors”. These monitor photodetectors 875, when connected to the two outermost arms of the star coupler, may advantageously be used to ensure that the optical demodulator is properly locked onto a transmitter wavelength.

In a preferred embodiment and as already noted, the monitor photodetectors 875 are connected to the two outermost arms of the star coupler. For example, if the output ports of the star coupler connected to the high-speed photodetectors are identified as ports 1, 2, 3, and 4, then the two monitor photodetectors are connected to ports 0 and 5—corresponding to the arms just outside of the output port arms. It is also noted that these monitor port arms are outside of the central Brillouin zone.

In a representative embodiment, the monitor photodetectors 875 are in communication with a control system 876 which, in turn, adjusts the thermooptic phase shifter, chip temperature or another method of adjusting the wavelength of the interferometer—either alone or in combination. In this advantageous manner, the control system may provide real time adjustment to the wavelength by monitoring the output of the monitor photodetectors and adjusting the wavelength accordingly. Normally, the control system will subtract the two monitor photodetector signals from each other and use that difference signal to make the adjustment(s) to thermooptic phase shifter(s), chip temperature, or other. For instance, if the difference signal is positive, the thermooptic phase shifter voltage should be increased, and if the difference signal is negative, the thermooptic phase shifter voltage should be decreased.

At this point, while we have discussed and described the invention using some specific examples, those skilled in the art will recognize that our teachings are not so limited. For example, this device could be built using a semiconductor material other than InP, such as silicon or GaAs. Accordingly, the invention should be only limited by the scope of the claims attached hereto.

1. A monolithic receiver comprising:
a semiconductor substrate chip;
a delay interferometer (DI) integrated upon the substrate, said MZDI including:
a first optical coupler having an input port and 2 output ports;
a second optical coupler having at least 2 input ports and at least two output ports;
one or more photodetectors connected to one or more output ports of the second optical coupler
two unequal length waveguide arms connecting the output ports of the first optical coupler to 2 output ports of the second optical coupler; and
at least one polarization-dependent phase shifter disposed within the waveguide arms
CHARACTERIZED IN THAT
the polarization-dependent phase shifter is adjusted to mitigate the polarization-dependent wavelength shift of the DI.

2. The receiver chip of claim 1 wherein the monolithic receiver functions as a DPSK receiver with low polarization sensitivity.

3. The receiver chip of claim 1 wherein the monolithic receiver functions as a DQPSK receiver with low polarization sensitivity.

4. The receiver chip of claim 1 wherein the polarization-dependent phase shifter is a current-injection phase shifter.

5. The receiver chip of claim 1 wherein the first optical coupler is a multimode interference coupler.

6. The receiver chip of claim 1 wherein the second optical coupler is a star coupler having at least 2 input ports and at least 4 output ports.

7. The receiver chip of claim 6 wherein said MZDI arms are connected to the central 2 input ports of the star coupler and four output waveguides are connected to the central 4 output ports of the star coupler.

8. The receiver chip of claim 1 wherein one or more of the photodetectors are high-speed photodiodes.

9. The receiver chip of claim 7 further comprising a set of two monitor photodetectors, each connected to an output port of the star coupler adjacent to the central four output ports of the star coupler.

10. The receiver chip of claim 9 further comprising a control system in communication with the monitor photodetectors such that controls the wavelength of the MZDI in order to keep the optical powers in the two monitor photodetectors equal.

11. The receiver chip of claim 9 wherein said output ports of the star coupler to which are connected the monitor photodetectors are outside the central Brillouin zone of the star coupler.

12. The receiver chip of claim 1 further comprising a waveguide loop, positioned within an arm of the DI, a thermooptic phase shifter substantially contacting the waveguide loop to provide a phase shift for adjusting the MZDI wavelength in a substantially polarization-independent manner.

13. A monolithic DQPSK receiver comprising:
a semiconductor substrate;
a Mach-Zehnder delay interferometer (MZDI) disposed upon the substrate, said MZDI including:
a 1×2 coupler;
a star coupler having at least 2 input ports and 2 output ports; and
a pair of unequal length waveguide arms connecting the 1×2 MMI to the central 2 input ports of the star coupler, wherein one of said waveguide arms includes a waveguide loop having a polarization-dependent phase shifter disposed within the optical path of the waveguide loop and a thermooptic phase shifter proximate to said loop;
at least four output waveguides connected to the at least four central output ports of the star coupler; and
at least four photodetectors, connected to the at least four output waveguides.

14. The receiver chip of claim 13 further comprising a set of two monitor photodetectors, each connected to an output port of the star coupler adjacent to the ports connected to the output waveguides.

15. The receiver chip of claim 14 wherein said output ports of the star coupler to which are connected the monitor photodetectors are outside the central Brillouin zone of the star coupler.

16. The receiver chip of claim 14 further comprising a control system in communication with the monitor photodetectors such that the control system adjusts the thermooptic phase shifter positioned proximate to the loop in order to keep the two optical signal levels from the two monitor photodetectors equal
